(19) United States
(12) Patent Application Publication
(10) Pub. No.: US 2024/0213499 A1
(43) Pub. Date: Jun. 27, 2024

(54) PRIMARY ALKALI METAL CELLS WITH GEMINAL DINITRILE ADDITIVES

(71) Applicant: LITRONIK Batterietechnologie Gmbh, Pirna (DE)

(72) Inventor: Sofiane BOUAZZA, Pirna (DE)

(73) Assignee: LITRONIK Batterietechnologie Gmbh, Pirna (DE)

(21) Appl. No.: 18/556,923

(22) PCT Filed: May 9, 2022
(86) PCT No.: PCT/EP2022/062452

§ 371 Date: Oct. 24, 2023

(30) Foreign Application Priority Data
May 12, 2021 (EP) 21173552.7

(51) Int. Cl. H01M 6/16; H01M 4/02; H01M 4/40; H01M 4/505

(52) U.S. Cl. CPC H01M 6/168; H01M 4/405; H01M 4/505; H01M 2004/027; H01M 2004/028

(57) ABSTRACT

The invention belongs to a primary cell. Said primary cell contains at least one anode, with an alkali metal as active anode material, at least one cathode with an active cathode material and an electrolyte. Additionally the electrolyte comprises at least one additive whereby it is in accordance with the inventive idea that the at least one additive is a nonionic or ionic compound having at least one geminal dinitrile moiety and is selected from the group consisting of aliphatic heterocycles, compounds of the formula

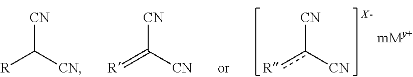

wherein M^{y+} denotes a counterion with a valence of y, and wherein R, R′ and R″ are substituents with an aliphatic or aliphatic heterocyclic backbone.

### CROSS-REFERENCE TO RELATED APPLICATIONS

This application is the United States National Phase under 35 U.S.C. § 371 of PCT International Patent Application No. PCT/EP2022/062452, filed on May 9, 2022, which claims the benefit of European Patent Application No. 21173552.7, filed on May 12, 2021, the disclosures of which are hereby incorporated by reference herein in their entireties.

### TECHNICAL FIELD

The present invention relates to a primary cell comprising at least one anode, with an alkali metal as active anode material, at least one cathode with an active cathode material and an electrolyte, wherein the electrolyte comprises at least one additive.

### BACKGROUND

A primary cell is a battery, wherein the electrochemical reactions occurring while in use are irreversible. So, primary cells are rendered non-rechargeable. In contrast, the electrochemical reactions of a secondary cell can be reversed by running a current into the cell, thereby regenerating the respective chemical reactants.

Whereas batteries comprising at least one secondary cell are especially favorable from an ecological point of view, primary batteries play an important role when charging is either impractical or impossible, such as during military combat, rescue missions or implanted medical devices. Moreover, primary batteries exhibit a superior specific energy and instant readiness even after long storage times as they show a much lower self-discharging rates, rendering them the battery type of choice for applications demanding a stable performance over long periods of time.

The use of anodes comprising an alkali metal as active anode material are considered favorable with respect to the theoretically achievable properties of the primary cell, such as high nominal voltage, high specific capacity and low self-discharge. In particular, lithium and sodium exhibit extremely high theoretical specific capacities (Li: 3860 mAh/g, Na: 1165 mAh/g), a low density (Li: 0.59 g/cm³; Na: 0.97 g/cm³) and negative electrochemical potential (Li: −3.04 V; Na: −2.71 V vs standard hydrogen electrode).

However, particular alkali metals are highly reactive, resulting in the formation of a passivation layer at the anode surface due to reactions with the cell electrolyte. This passivation layer is known solid-electrolyte interphase (SEI) and significantly influences the cells performance. Since the formation of a SEI is unavoidable, the SEI is required to be sufficiently stable and electrically insulating to prevent further degradation reactions. However, the usually low ionic conductivity of the SEI results in an increase of the impedance inside the cell. Consequently, the discharge voltage and battery capacity decreases.

Under pulse discharge conditions—amongst others a common operation mode for implantable primary cells used in medical devices—the high-ohmic SEI results in a so-called voltage delay, whereby the minimum potential of the first pulse is lower than the minimum potential of the subsequent pulse leading to a non-monotonous discharge behavior. This effect is especially pronounced in alkali metal/metal oxide cells after elongated storage or inactivity periods, during which cathode material is slowly dissolved and subsequently deposited on the anodic surface, or when the ratio of delivered capacity to the theoretical capacity times 100 (called depth of discharge (DOD)) is over 40% of the cell capacity as it is shown in U.S. Pat. Nos. 6,063,526, 5,753,389, 6,027,827, 5,753,389 and 6,274,269.

Another major problem in alkali metal cells is the formation and deposition of alkali metals on the anodic surface or the inner surfaces of the cell components including the lid, casing, collectors or cathode pin. The formation of metallic lithium deposits occurs if the potential of the respective component is below deposition potential of the respective alkali metal, e.g., U<0 V vs. Li/Li⁺. In this context, the term “inner surface of the cell” comprises the surfaces of the inner components that are or may come in contact with the electrolyte, including but not limited to the lid of the cell, the casing or the current collectors.

Multiple reasons can cause this condition, e.g., due to a local increase of the Li⁺ ion concentration in the electrolyte if the diffusion of lithium within the active particles is lower than the transport of Li⁺ ions in the electrolyte. If the locally increased lithium concentration moves toward current collector or other accessible inner surface elements with anodic potential excess lithium ions can deposit to lithium metal Moreover, an increase of the ohmic resistance may lead to a reduced anode potential, e.g., if the electric conductivity of the electrode or the ionic conductivity of the electrolyte deteriorates.

The depositions are irregular in a granular or dendritic form. In the worst case positive and negative compounds of the cell are being bridged causing an internal short-circuit.

U.S. Pat. No. 6,274,269 discloses the use of phosphate additives in the non-aqueous, low viscous electrolyte comprising of an inorganic alkali metal salt of an electrochemical cell to modify the anodic SEI to be ionically conductive, thereby minimizing the voltage delay.

In a similar way, U.S. Pat. No. 7,871,721 describes an electrolyte solvent for secondary lithium ion battery comprising an aliphatic mononitriles (R—C≡N) with R being a linear C₁ to C₁₅ alkane. Thereby, the stability of the electrolyte during charge/discharge cycles is improved.

From document U.S. Pat. No. 6,333,425 malononitrile salts or malononitrile ionic compounds are known to improve to improve the electrolyte's conductivity.

Mixtures of specific nitrile solvent and dinitrile solvent are taught in U.S. Pat. No. 9,666,906 for being admixed to a high voltage electrolyte to stabilize it during charging.

However, neither of the approaches are directed to primary cells. Therefore, the additives known from prior art are not related to the two problems outlined above. This holds particularly true for primary alkali metal/metal oxide cells, which are prone to deposition of dissolved cathode material on the anodic surface, when being applied in long term and/or high current applications, e.g., as batteries for cardiac pacemakers, loop recorders, internal cardiac defibrillators (ICD), or neurostimulation

The present disclosure is directed toward overcoming one or more of the above-mentioned problems, though not necessarily limited to embodiments that do.

### SUMMARY

It is, therefore, an object of the present invention to provide a primary alkali metal cell suited to be used in long term and/or high current applications while concomitantly suppressing the deposition of respective alkali metal and cathode material on the anodic surface as well as on the inner surfaces of the cell compounds.

At least this object is accomplished by a primary alkali metal cell with the features of current claim 1.

A primary cell according to claim 1 comprises at least one anode, wherein the at least one anode comprises an alkali metal as active anode material, at least one cathode, wherein the at least one cathode comprises an active cathode material, and an electrolyte, wherein the electrolyte comprises at least one additive.

The at least one additive is a nonionic or ionic compound having at least one geminal dinitrile moiety and is selected from the group consisting of aliphatic heterocycles, compounds of the formula (I)

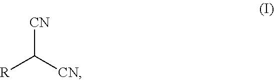

compounds of the formula (II)

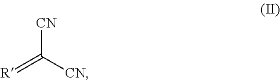

or compounds of the formula (III)

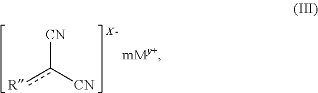

wherein M^{y+} denotes a counterion with a valence of y, and wherein R, R′ and R″ are substituents with an aliphatic or aliphatic heterocyclic backbone.

The term “aliphatic” denotes acyclic or cyclic, saturated or unsaturated moieties, that do not fulfill the criteria of aromaticity, i.e., cyclic, (essentially) planar and 4n+2 electrons in a conjugated system of p-orbitals. In addition to the at least one geminal nitrile moiety, the geminal nitriles as according to the present invention have in common, that their respective backbones, i.e., the basic structure of the heterocycle, R, R′ or R″, are aliphatic. However, substituents of the aliphatic backbone or heterocycle may still be of aromatic nature.

Surprisingly, it was found that the addition of nonionic or ionic compounds having at least one geminal dinitrile moiety selected from the group of aliphatic heterocycles or compounds of the general formulas I to III, hereinafter referred to as “geminal dinitriles”, to the electrolyte of a primary alkali metal cell effectively suppresses the deposition of the alkali metal on the anode surface and other inner surfaces of the cell due. This observation may be explained by the formation of a stable SEI even in high rate and high current pulse discharge applications, wherein the term “pulse” as used herein refers to a short burst of an electrical current, wherein the amplitude is significantly greater than the currents prior or after said pulse. A pulse train is series of pulses in relatively short succession.

Moreover, the deposition of cathode material onto the anode surface is minimized or eliminated completely, thereby stabilizing the impedance of the cell. Consequently, the primary alkali metal cells as according to the present invention do not exhibit a voltage delay even after extended periods of non-use or at a depth of discharge greater than 40%, enhancing the reliability and the lifespan of the cell.

It is within the scope of the present invention that several primary cells are combined to battery. A battery generally comprises at least one electrochemical cell and multiple cells may be combined in a series and/or parallel circuit. Herein, the terms cells, primary (alkali metal) cells, primary (alkali metal) batteries and batteries are considered as collective terms and used interchangeably where applicable.

In a preferred embodiment of the present invention the nonionic compounds having at least one geminal dinitrile moiety are selected from the group consisting of:

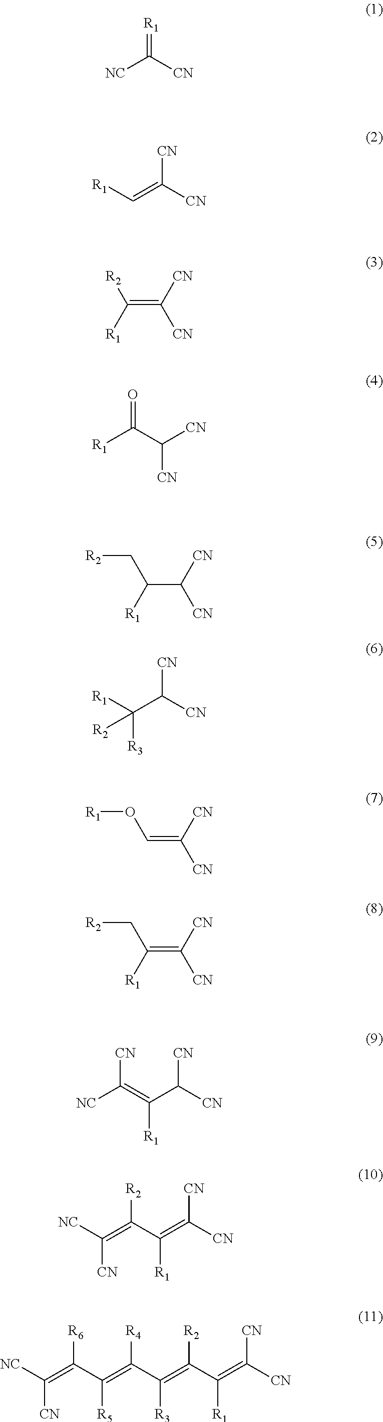

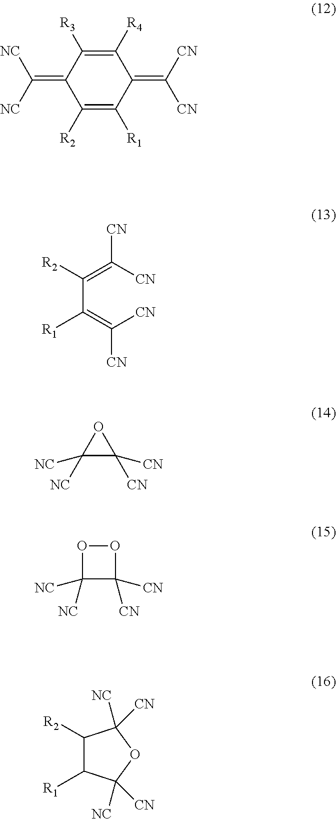

wherein R₁, R₂, R₃, R₄, R₅, and R₆, independently of one another, denote hydrogen, unsubstituted, mono- or multi-substituted alkyl, alkenyl, cycloalkyl, thioether, heterocyclic, aryl and/or heteroaryl substituents.

Some compounds are preferred representatives for the Markush structures given above. In details, these are for structure (1): 2-methylidenepropanedinitrile, Benzalmalononitrile, 4-(Dicyanomethylene)-2,6-dimethyl-4H-pyran, Tyrphostin A1, Tyrphostin A23, 3-(Dicyanomethylidene)indan-1-one, 2-(Dicyanomethylene)indan-1,3-dione, 2-Fluoro-7,7,8,8-tetracyanoquinodimethane, (3,5,5-Trimethylcyclohex-2-enyliden)-malononitrile; for structure (2): Benzylidenemalononitrile, 2-(2,4,6-Trimethyl-Benzyliden)-Malononitrile, 2-(2,4-Dimethyl-Benzylidene)-Malononitrile, 2-(3-Furylmethylene)Malononitrile, 2-ethylidenepropanedinitrile; for structure (3): Isopropylidenemalononitrile, Tetracyanoethylene, 2-Amino-1,1,3-tricyano-1-propene, 2-[bis(dimethylamino)methylidene]propanedinitrile; for structure (4): Acetylmalononitrile, 2-Benzoylmalononitrile; for structure (5): 2-(1-cyclopropylethyl)propanedinitrile; for structure (6): tert-Butylmalononitrile, ethane-1,1,2-tricarbonitrile, ethane-1,1,2,2-tetracarbonitrile; for structure (7): (Ethoxymethylen)malononitril, (1-Ethoxyethylidene)malononitrile, 2-(3-oxobutan-2-ylidene)propanedinitrile; for structure (8): 2-(2-bromo-1-methylethylidene)malononitrile, 2-(2-Chloro-1-methylethylidene)malononitrile 2-(butan-2-ylidene)propanedinitrile; for structure (9): 2-methylprop-1-ene-1,1,3,3-tetracarbonitrile, prop-1-ene-1,1,2,3,3-pentacarbonitrile; for structure (10): 1,3-Butadiene-1,1,2,3,4,4-hexacarbonitrile; for structure (11): Decacyanooctatetraene; for structure (12): 7,7,8,8-Tetracyanoquinodimethane, 2-Fluoro-7,7,8,8-tetracyanoquinodimethane, 2,5-Dimethyl-7,7,8,8-tetracyanoquinodimethane, 2,5-Difluoro-7,7,8,8-tetracyanoquinodimethane, Tetrafluorotetra-cyanoquinodimethane; for structure (13) 1,1,4,4-tetracyanobuta-1,3-diene; for structure (14): Tetracyanoethylene Oxide; for structure (15): 3,3,4,4-tetracyano-1,2-dioxetane; for structure (16): 3-chlorooxolane-2,2,5,5-tetracarbonitrile.

Further, it is preferred that the ionic compounds having at least one geminal dinitrile moiety are selected from the group consisting of:

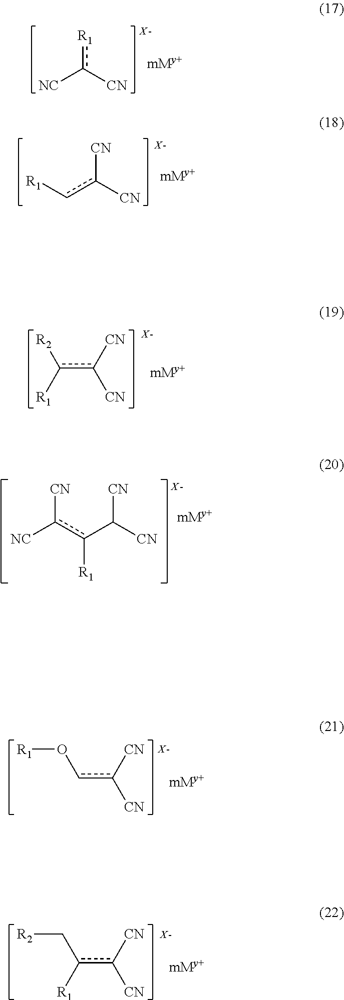

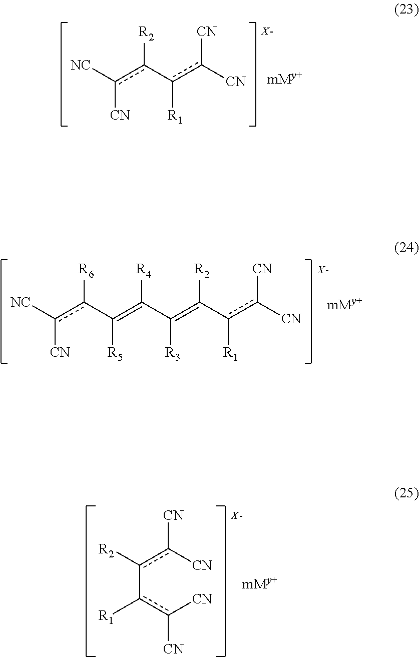

wherein R₁, R₂, R₃, R₄, R₅, and R₆, independently of one another, denote hydrogen, unsubstituted, mono- or multi-substituted alkyl, alkenyl, cycloalkyl, thioether, heterocyclic, aryl and/or heteroaryl substituents.

Possible compounds for the Markush structures given above are:

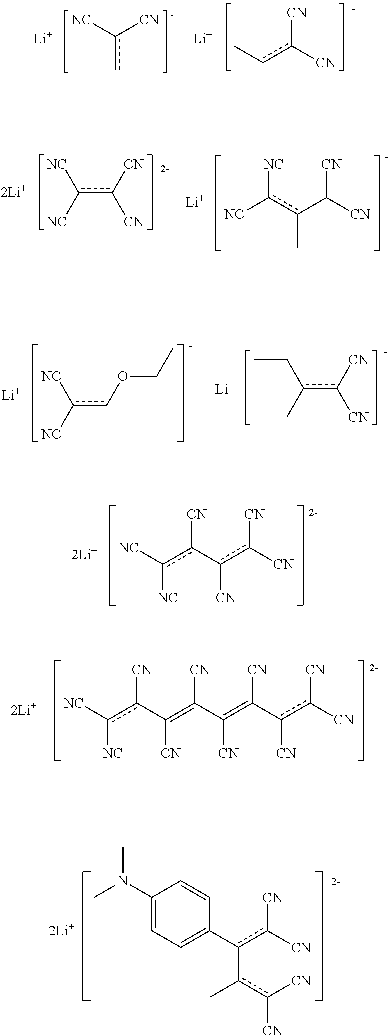

In a preferred embodiment, the substituents of mono- or multi-substituted R₁, R₂, R₃, R₄, R₅, and R₆ moieties for the compounds of the general structures 1 to 25 are selected independently of one another from the group comprising alkyl, fluoroalkyl, alkoxy, carbonyl, carboxyl, thiol, thioalkoxide, aryl, ether, thioether, nitro, cyano, amino, azido, amidino, hydrazino, hydrazono, carbamoyl, sulfo, sulfamoyl, sulfonylamino, alkylaminosulfonyl, alkylsulfonylamino moieties, and/or halogens, preferably halogens, fluoroalkyl and/or cyano moieties as they show particularly good results.

Compounds of structures 1 to 25 are accessible by standard synthetic procedures reported in literature. A different backbone as well as variation of the individual substituents allows to specifically adapt the properties of the geminal dinitrile to the electrolyte, the active anode and cathode material. By changing the solubility, pKₐ value or dissociation constant among others the composition and stability of the formed SEI layer is also affected.

Ionic geminal dinitriles form a net neutral salt with a sufficient number m of counterions M^{y+} with a valence of y. Preferably, y equals 1 or 2, m equals 1 or 2 and the counterion M^{y+} is selected from the group comprising nitrosonium (NO⁺), ammonium (NH₄⁺), alkali metal ions, metal ions of valence y, organic ions of valence y and/or an organometallic cations of valence y for the ionic geminal dinitrile additive as they show a particularly good performance.

According to an embodiment the at least one additive, i.e., the geminal dinitrile, has a concentration of 0.0005 mol/l to 0.5 mol/l, preferably 0.005 mol/l to 0.4 mol/l, most preferably 0.05 mol/l to 0.3 mol/l in the electrolyte. At concentrations below 0.0005 mol/l the beneficial effects of the geminal dinitrile are hardly noticeable, whereas concentrations higher than 0.5 mol/l do not lead to any further noteworthy decrease of the lithium deposition or voltage delay.

In addition to the geminal dinitrile as additive, the electrolyte comprises at least one solvent and may further comprise at least one conductive salt.

Suitable solvents for the electrolyte are non-aqueous, aprotic, organic solvents. Preferably, these solvents are selected from esters, ethers and dialkyl carbonates, such as tetrahydrofuran, glyme, diglyme, 1,2-dimethoxyethane, 1,2-diethoxyethane, ethyl methyl carbonate, methyl propyl carbonate, diethyl carbonate and mixtures thereof. Moreover, cyclic carbonates, cyclic esters, cyclic amides and sulfoxides were found to be suitable solvents. These solvents include but are not limited to ethylene carbonate, propylene carbonate, acetonitrile, dimethyl formamide, dimethyl acetamide, N-methyl-pyrrolidinone or mixtures thereof.

The conductive salt is preferably an inorganic alkali metal salt, whereby the alkali metal cation is the same as the active anode material. Suitable anions are PF₆⁻, BF₄⁻, AsF₆⁻, SbF₆⁻, ClO₄⁻, O₂⁻, AlCl₄⁻, GaCl₄⁻, SCN⁻, SO₃(C₆F₅)⁻, C(SO₂CF₃)₃⁻, N(SO₂CF₃)₂⁻ and SO₃CF₃ among others. In a preferred embodiment, the concentration of the conductive salt in the electrolyte is between 0.5 to 2.0 mol/l, preferably 0.8 to 1.5 mol/l.

In a preferred embodiment the alkali metal used as active anode material is metallic sodium, a sodium alloy, metallic lithium or a lithium alloy, preferably lithium or a lithium alloy. Anodes based on sodium, lithium and their alloys are especially suited due to their high theoretical specific capacities and negative electrochemical potential. Moreover, both alkali metals are cheap and readily available as compared to their heavier homologues.

The shape of the anode is not limited to a specific form. Preferably, the anode is in form of a thin sheet or foil, which is conductively connected at least on metallic anode current collector, e.g., by pressing or welding. Further embodiments include disk-, cylindrical, rod-shaped or folded anodes.

The cathode is preferably a solid material and may comprise a metal, a metal oxide, a mixed metal oxide, a metal sulfide, carbonaceous compounds or mixtures thereof.

In a further embodiment of the present invention, the active cathode material is MnO₂, silver vanadium oxide (SVO), copper silver vanadium oxide (CSVO), V₂O₂, TiS₂, CuO₂, Cu₂S, FeS, FeS₂, CFₓ (fluorographites), Ag₂O, Ag₂O₂, CuF, Ag₂CrO₄, CuO, Cu₂P₂O₇, Cu₄P₂O₉, Cu₅P₂O₁₀, Ag₂Cu₂P₂O₈, Ag₂Cu₃P₂O₉, copper vanadium oxide or a mixture thereof, preferably MnO₂.

If necessary, a binder material is added to the active cathode material during the preparation of the cathode. Said binders usually make up for in 1.0 to 10 wt % of the total cathode material mixture. Suitable materials include powdered fluoropolymers, such as polytetrafluoroethylene or polyvinylidene fluoride.

Moreover, one or more additives to improve the cathode conductivity, including graphite or carbon black, may be added to the cathode material. Preferably, these additives account for 1.0 to 10 wt % of the total cathode material mixture.

Preferably, the cathode is conductively connected at least on metallic cathode current collector, which may be in form of a thin sheet of metal foil or a grid such as a mesh grid, coated with a thin layer of graphite and/or carbon. Suitable materials are selected from but not limited to titanium, gold, stainless steel, cobalt nickel, molybdenum or steel alloys.

In a preferred embodiment, the primary cell is a lithium metal battery comprising at least one anode with lithium as active anode material and at least one cathode with MnO₂ as active cathode material. This combination is especially attractive, since the advantages of lithium outlined above are combined with MnO₂, which is highly stable, high potential capacity and low-cost material. Whereas the nominal voltage of 3.0 V is lower than that of, e.g., lithium thionylchloride (3.6 V), Li—MnO₂ achieve significantly higher currents (up to 5 A continuous load and up to 10 A pulse load).

However, cells with a cathode comprising MnO₂ as active material are prone to develop a voltage-delay due to the deposition of manganese on the anode surface, which partially offsets the favorable characteristics of the material itself. Surprisingly, it was found that the addition of a geminal dinitrile to the electrolyte as according to the present invention effectively suppresses said deposition, thus allowing to use primary lithium metal MnO₂ cells to their fullest extent.

In order to avoid an internal short-circuit, the electrodes are separated by a separator made of an electrically insulative material, which is also chemically inert, i.e., does not react with the anode or cathode material, as well as the electrolyte. Nonetheless, the separator allows the diffusion of ions when moistened with the electrolyte, i.e., Li⁺ ions from the anode to the cathode during discharge. Suitable materials are polyolefines, such as polyethylene or polypropylene, or fluoropolymers, such as polyethylenetetrafluoroethylene, among others. Preferably, the separator is in form of a membrane.

The cell components are arranged within a casing, which is compatible with materials of the anode, cathode and electrolyte. The casing may comprise materials such as titanium, aluminum or stainless steel among others.

The present invention further includes the use of a primary alkali metal cell with a geminal dinitrile additive as a battery in a medical device, or an implantable battery in an implantable medical device.

Accordingly, the present invention further includes a medical device, particularly an implantable medical device, comprising the primary alkali cell according to the present invention.

Cardiac pacemakers, cardioverter defibrillators (ICDs), drug delivery pumps or neurostimulators are examples of active implantable medical devices which are battery powered.

Especially pacemakers and ICDs depend on batteries that allow a consistent delivery of pulses even after extended periods of inactivity. If an acute cardiac event is detected, high current pulses are delivered to prevent a possible cardiopulmonary arrest. Even when operated under such unfavorable conditions, the primary cells as according to the present invention neither exhibit a considerable amount of unwanted lithium deposition nor a voltage delay.

Developments, advantages and application possibilities of the present invention also emerge from the following description of the examples and the drawings. All features described and/or illustrated in the drawings form the subject matter of the present invention per se or in any combination independently of their inclusion in the claims or their back references.

Additional features, aspects, objects, advantages, and possible applications of the present disclosure will become apparent from a study of the exemplary embodiments and examples described below, in combination with the Figures and the appended claims.

### BRIEF DESCRIPTION OF THE DRAWINGS

In the figures:

FIG. 1 is a graph showing an illustrative pulse discharge curve of a primary cell as according to example 1.

FIG. 2 is a graph showing an illustrative pulse discharge curve of a primary cell as according to example 2.

FIG. 3 is a graph showing an illustrative pulse discharge curve of a primary cell as according to example 3.

FIG. 4 is a graph showing an illustrative pulse discharge curve of a primary cell as according to comparative example C1.

FIG. 5 is a graph showing the total amounts of deposited lithium on the inner lid surface, the inner housing surface and contact components of cells 1 to 20.

FIG. 6 is a graph showing a comparison of the cyclic voltammograms of electrolyte 1 with and without tetracyanoethylene as additive.

FIG. 7A is a graph showing an illustrative first pulse discharge of an electrochemical cell without voltage delay.

FIG. 7B is a graph showing an illustrative second pulse discharge of an electrochemical cell without voltage delay.

FIG. 8A is a graph showing an illustrative first pulse discharge of an electrochemical cell with voltage delay.

FIG. 8B as a graph showing an illustrative second pulse discharge of an electrochemical cell with voltage delay.

FIG. 9A is a graph showing the development of the 1 kHz-impedance of a primary cell as according to example 2.

FIG. 9B is a graph showing the development of the kHz-impedance of a primary cell as according to comparative example C1.

FIG. 10A is a graph showing an illustrative pulse discharge of a primary cell as according to example 2 after a 30-day recovery phase.

FIG. 10B is a graph showing an illustrative pulse discharge of a primary cell as according to comparative example C1 after a 30-day recovery phase.

FIG. 11A is a graph showing an illustrative cyclic voltammogram the standard electrolyte with 0.01 M tetracyanoethylene.

FIG. 11B is a graph showing a comparison of the cyclic voltammograms of the standard electrolyte with and without tetracyanoethylene as additive in presence of Mn²⁺ ions.

FIG. 12 is a graph showing a comparison of the cyclic voltammogram's of the standard electrolyte with and without tetracyanoethylene as additive in presence of Fe²⁺ ions.

### DETAILED DESCRIPTION

The following examples illustrate the current invention, but the present invention is not limited by and to these examples. All examples are shown in table 1.

Primary lithium metal MnO₂ cells are used as model system to determine the effect of the geminal dinitriles on the lithium deposition as well as a voltage delay. The cathode comprises MnO₂ as active cathode material, mixed with graphite (3 wt % of total composition) and carbon black (2 wt % of total composition) as conductive additives as well as polytetrafluoroethylene (3 wt % of total composition) as binder. The anode comprises metallic lithium and the electrolyte comprises LiClO₄ (1 mol/l) in a mixture of 1,2-dimethoxyethan, ethylencarbonate and propylencarbonate (ratio 4:4:2 (v/v)). Further the geminal dinitriles tert-butylmalononitrile (TBMN), tetracyanoethylene (TCNE) and acetylmalononitrile (AMN) were added in a concentration of 0.02 mol/l to the electrolyte (see Examples 1, 2 and 3 in table below. Primary lithium metal MnO₂ cells without a geminal dinitrile additive are used as comparative examples C1. Multiple cells (see cells 1 to 20) of each example outlined above were analyzed to ensure reproducibility of the results.

TABLE 1
Examples with different electrolytes.

| Example | cell no. | electrolyte |
|---|---|---|
| Example | cell 1 | LiClO₄ (1 mol/l) in 1,2-dimethoxyethan, ethylencarbonate and |
| 1 | | propylencarbonate (4:4:2) + TBMN (0.02M) |
| | cell 2 | LiClO₄ (1 mol/l) in 1,2-dimethoxyethan, ethylencarbonate and |
| | | propylencarbonate (4:4:2) + TBMN (0.02M) |
| | cell 3 | LiClO₄ (1 mol/l) in 1,2-dimethoxyethan, ethylencarbonate and |
| | | propylencarbonate (4:4:2) + TBMN (0.02M) |
| | cell 4 | LiClO₄ (1 mol/l) in 1,2-dimethoxyethan, ethylencarbonate and |
| | | propylencarbonate (4:4:2) + TBMN (0.02M) |
| | cell 5 | LiClO₄ (1 mol/l) in 1,2-dimethoxyethan, ethylencarbonate and |
| | | propylencarbonate (4:4:2) + TBMN (0.02M) |
| Example | cell 6 | LiClO₄ (1 mol/l) in 1,2-dimethoxyethan, ethylencarbonate and |
| 2 | | propylencarbonate (4:4:2) + TCNE (0.02M) |
| | cell 7 | LiClO₄ (1 mol/l) in 1,2-dimethoxyethan, ethylencarbonate and |
| | | propylencarbonate (4:4:2) + TCNE (0.02M) |
| | cell 8 | LiClO₄ (1 mol/l) in 1,2-dimethoxyethan, ethylencarbonate and |
| | | propylencarbonate (4:4:2) + TCNE (0.02M) |
| | cell 9 | LiClO₄ (1 mol/l) in 1,2-dimethoxyethan, ethylencarbonate and |
| | | propylencarbonate (4:4:2) + TCNE (0.02M) |
| | cell 10 | LiClO₄ (1 mol/l) in 1,2-dimethoxyethan, ethylencarbonate and |
| | | propylencarbonate (4:4:2) + TCNE (0.02M) |
| Example | cell 11 | LiClO₄ (1 mol/l) in 1,2-dimethoxyethan, ethylencarbonate and |
| 3 | | propylencarbonate (4:4:2) + AMN (0.02M) |
| | cell 12 | LiClO₄ (1 mol/l) in 1,2-dimethoxyethan, ethylencarbonate and |
| | | propylencarbonate (4:4:2) + AMN (0.02M) |
| | cell 13 | LiClO₄ (1 mol/l) in 1,2-dimethoxyethan, ethylencarbonate and |
| | | propylencarbonate (4:4:2) + AMN (0.02M) |
| | cell 14 | LiClO₄ (1 mol/l) in 1,2-dimethoxyethan, ethylencarbonate and |
| | | propylencarbonate (4:4:2) + AMN (0.02M) |
| | cell 15 | LiClO₄ (1 mol/l) in 1,2-dimethoxyethane, ethylencarbonate and |
| | | propylencarbonate (4:4:2) + AMN (0.02M) |
| Comparative | cell 16 | LiClO₄ (1 mol/l) in 1,2-dimethoxyethane, ethylencarbonate and |
| example | | propylencarbonate (4:4:2) |
| C1 | cell 17 | LiClO₄ (1 mol/l) in 1,2-dimethoxyethane, ethylencarbonate and |
| | | propylencarbonate (4:4:2) |
| | cell 18 | LiClO₄ (1 mol/l) in 1,2-dimethoxyethane, ethylencarbonate and |
| | | propylencarbonate (4:4:2) |
| | cell 19 | LiClO₄ (1 mol/l) in 1,2-dimethoxyethane, ethylencarbonate and |
| | | propylencarbonate (4:4:2) |
| | cell 20 | LiClO₄ (1 mol/l) in 1,2-dimethoxyethane, ethylencarbonate and |
| | | propylencarbonate (4:4:2) |

Herein, the term “standard electrolyte” is used for a 1 mol/l solution of LiClO₄ in a mixture of 1,2-dimethoxyethan, ethylencarbonate and propylencarbonate (4:4:2 (v/v).

In order to provoke the deposition lithium on the anode surface as well the inner surfaces of the metallic passive parts, cells 1 to 25 were subjected to a 16-day test until cutoff voltage of 1.5 V has been reached in order to simulate usage in an ICD under accelerated conditions. The daily pulse trains consisted of 25 pulses with a duration of 10 seconds, a current density of 39 mA/cm² and a voltage of up to 1.5 V. The resting period in-between two pulses was 15 seconds and the testing temperature was set to 37° C. to mimic a human's body temperature. Upon finishing the testing period, the cells were opened and the inner surfaces, in particular the inner surface of the lid, were analyzed for lithium depositions using inductively coupled plasma atomic emission spectroscopy (ICP-OES).

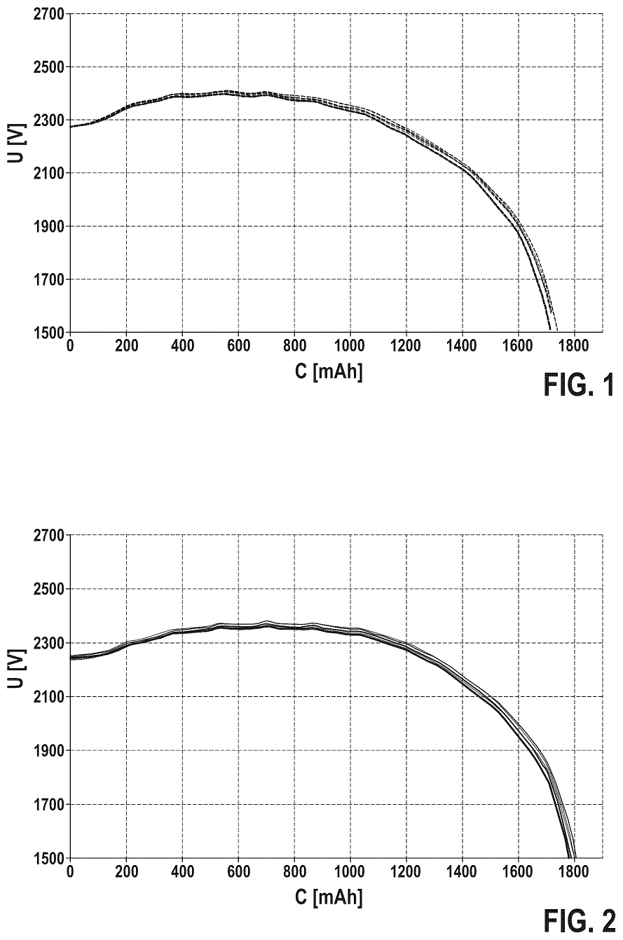

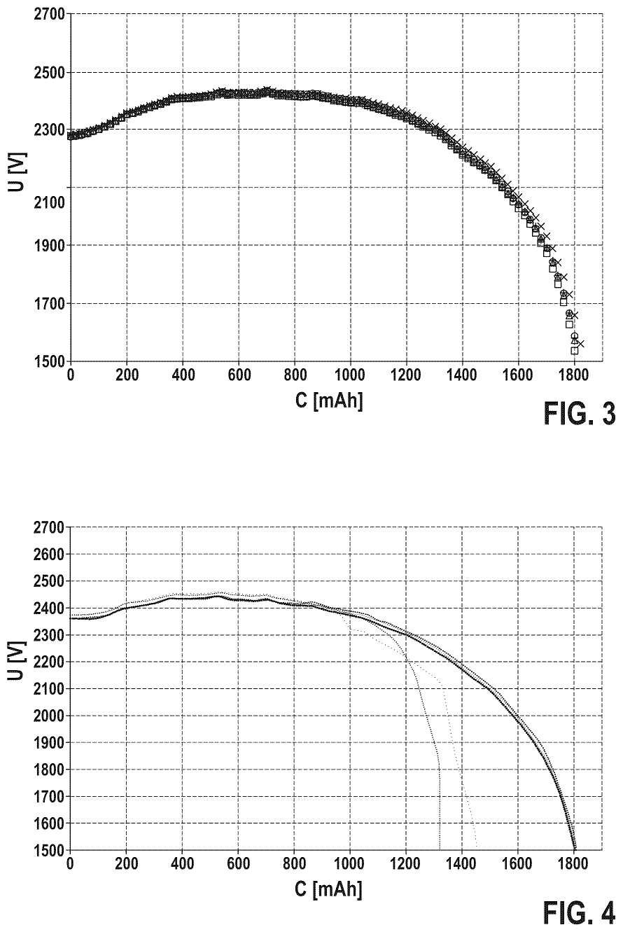

The graphs depicted in FIGS. 1 to 4 show the pulse discharge curves of primary cells as according to examples 1, 2, 3 and comparative example C1. The cells according to examples 1, 2 and 3 exhibit a similar behavior during testing period.

The initial voltage is about 2.25 V, which subsequently rises to reach a maximum of approximately 2.35 to 2.4 V after around 600 to 700 mAh. This initial increase may be attributed to structure changes of the cathode active material during the cell discharge, particularly for the use of MnO₂, mostly a change from Pyrolusite structure to Spinel Structure is observed.

After reaching its maximum the measured voltage drops only slowly initially, thus creating a plateau between 0 and 1200 mAh. During this plateau phase the cell's output remains effectively constant. After the voltage falls below the initial voltage, the drop in voltage subsequently accelerates until the cutoff voltage of 1.5 V is reached at around 1800 mAh, which denoted the end of life of the respective cell.

It becomes immediately obvious, that the presence of a geminal dinitrile as according to the present invention reproducibly leads to a near-identical behavior of each individual cell, i.e., the individual discharge curves only differ by a small margin.

A comparison of examples 1 to 3 to the cells lacking a geminal dinitrile, i.e., cells 16 to 20 of comparative example C1, shows, that despite having a slightly higher initial voltage (approximately 2.37 V as compared to 2.25 V) and higher maximum voltage (approximately 2.45 V at 500 mAh) the end of the desired plateau is already reached at about 1000 mAh.

Moreover, two cells exhibited a sharp drop in voltage immediately after the end of the plateau phase, thus reaching the cutoff voltage of 1.5 V prematurely at 1400 mAh. This observation is attributed to an excessive deposition of metallic lithium resulting in a bridging of the anode and another metallic component of the cell. Consequently, the cell gets drained due to an internal short-circuit.

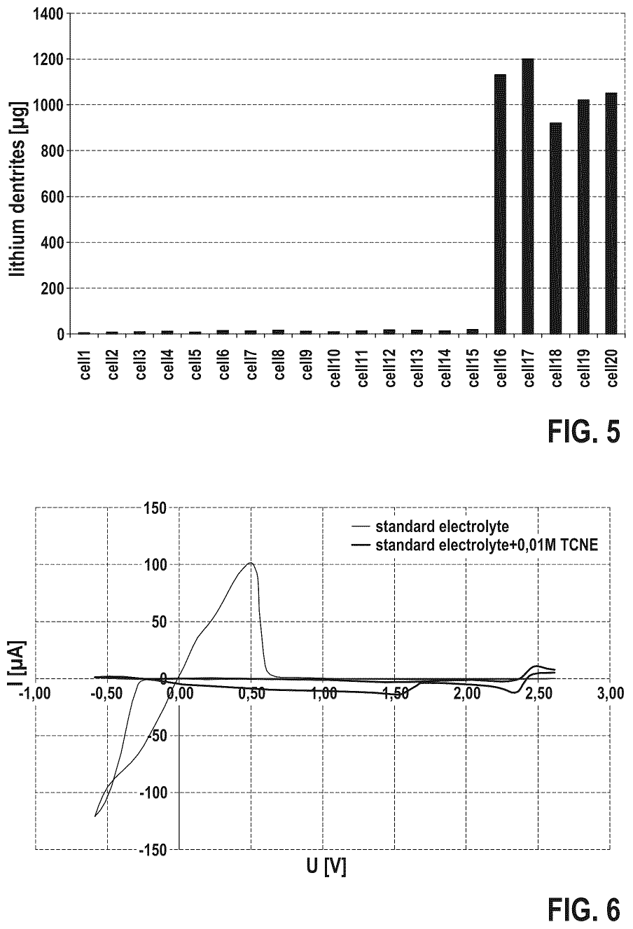

FIG. 5 shows the total amounts of deposited lithium on the inner lid surface, the inner housing surface and contact components of cells 1 to 20. The beneficial effect of the geminal dinitrile additive becomes immediately obvious. Whereas the primary cells featuring a geminal dinitrile exhibit hardly any lithium deposition even after the testing period, the determined amount of lithium ranged between 950 to 1200 μg for comparative cells 16 to 20, thus exceeding cells as according to the present invention by up to three orders of magnitude.

The influence of the geminal dinitrile additive was further investigated by cyclovoltammetry (CV). CV is a common method to study redox and follow-up reactions taking place in a cell. Thereby, valuable information regarding the reactions themselves, possible depositions and the effect of additives in the electrolyte can be obtained. CV is a potentiodynamic method, whereby the potential of the working electrode is ramped linearly versus time. Once the desired potential is reached, the working electrode's potential is ramped in the opposite direction to return to the initial potential, thus leading to a triangular potential-time function. The current at the working electrode is plotted versus the applied voltage to give the cyclic voltammogram.

FIG. 6 shows a comparison of the standard electrolyte with and without TCNE (0.01 mol/l). The CV setup comprises a platinum working electrode, a platinum counter electrode and a lithium reference electrode. The scan rate was set to 50 mV/s.

The cyclic voltammogram of the standard electrolyte shows two distinct peaks, whereby the reduction of Li⁺ ions to metallic lithium is observed in a potential range between 0 V and −0.6 V (vs. Li/Li⁺). This corresponds to the deposition of lithium. The back scan shows the oxidation of the metallic lithium to Li⁺ ions in a potential range between 0V and 0.6 V (vs Li/Li⁺), corresponding to a dissolution of lithium in the electrolyte. The reduction and oxidation reactions are as follows:

Reduction: Li⁺+e⁻→Li⁰

Oxidation: Li⁰→Li⁺+e⁻

In contrast to the two distinct peaks in the cyclic voltammogram of the standard electrolyte, the addition of TCNE in a concentration of 0.01 mol/l shows two reduction peaks at E_{red1}=2.34 V and E_{red2}=1.41 V, indicating the reduction of the TCNE additive on the electrode surface. The lack of corresponding oxidation peaks suggests that these reactions are irreversible, forming a stable SEI layer. Moreover, the reduction reactions of the TCNE prevents the subsequent reduction of Li⁺ ions and thus deposition of metallic lithium on the inner surfaces. This is confirmed by the absence of the redox peaks observed for the standard electrolyte without the geminal dinitrile additive.

Lithium MnO₂ cells are based on the intercalation of Li⁺ ions into the MnO₂ lattice. The underlying redox reactions are as follows:

Anode: Li⁰→Li⁺+e⁻

Cathode: Mn^{IV}O₂+Li⁺+e⁻→LiMn^{III}O₂

Total: Li⁰+MnO₂→LiMnO₂

Whereas the overall reaction is irreversible, the dissolution of manganese ions under certain conditions and their subsequent deposition on the anode surface results in the formation of a high-resistance surface layer leading to an increase of the impedance and a voltage delay, respectively.

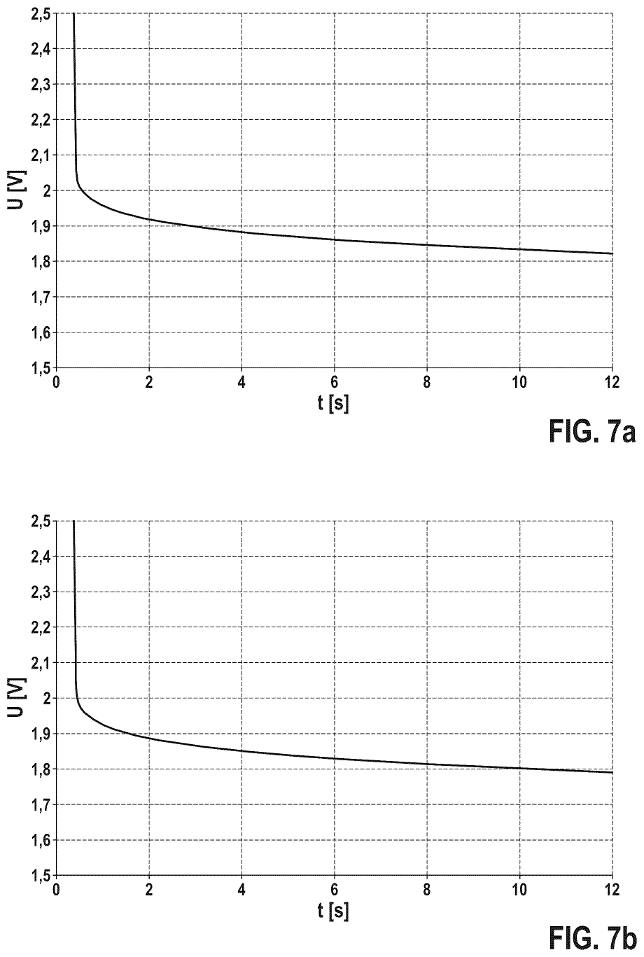

FIGS. 7A and 7B show an illustrative first and second pulse discharge of an electrochemical cell without voltage delay. For both pulses the cell potential decreases throughout the pulse duration, reaching a minimum at the end of a pulse. Moreover, the minimum potential of the first pulse is higher than the minimum potentials of subsequent pulses in a pulse train.

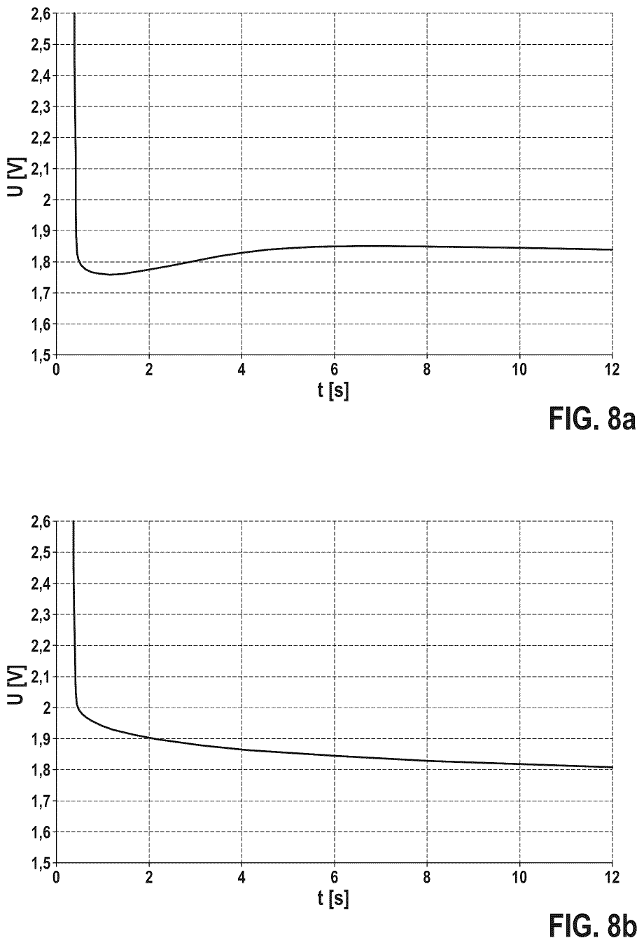

However, if a cell exhibits a voltage delay, the leading-edge potential of the first pulse forms a minimum potential, which is lower than the end potential of the first pulse. This behavior reflects the increased cell impedance due to the formation of high-resistance surface layers on the electrodes, thereby limiting the effectiveness and in the worst case the proper functioning of the cell and the supplied electronic device. FIGS. 8A and 8B show an illustrative first and second pulse discharge of an electrochemical cell exhibiting voltage delay.

In order to provoke the deposition of manganese on the anode surface, three cells as described, for example 1, and for comparative example C1, respectively, were discharged to 90% DOD. This was achieved under pulse discharge conditions with pulse trains consisting of four pulses with a duration 10 seconds each, a current density of 33 mA/cm², a 10 second resting period in between two pulses, and a 30-minute period in between two pulse trains.

Subsequently, a 30-day recovery period followed, in which the cells were further discharged with a load of just 100 kΩ. Thereby, the manganese dissolved during the pulse discharge could form a high-resistance layer on the surface.

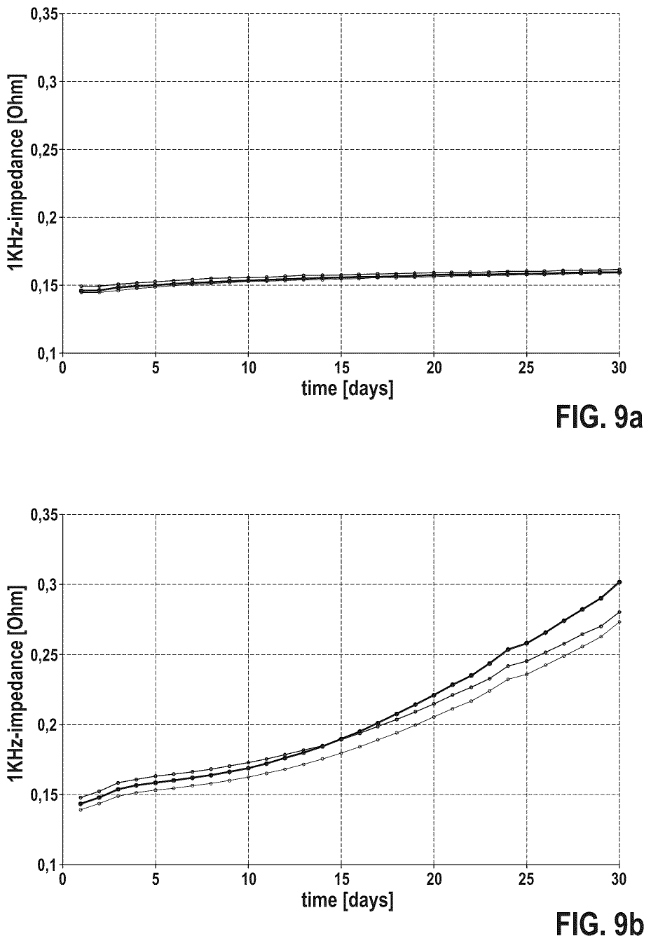

FIGS. 9A and 9B show the development of the impedance measured of cells according to example 1 and comparative example C1, respectively. The data shown was obtained by impedance measurement at 1 KHz. Whereas the impedance of the cells in presence of TCNE remains essentially constant (approximately 0.16Ω) over the 30-day recovery period, the impedance of C1 cells doubled to nearly 0.3Ω. This observation already pronounces the excellent long-term stability of the primary cells comprising a geminal dinitriles as according to the present invention.

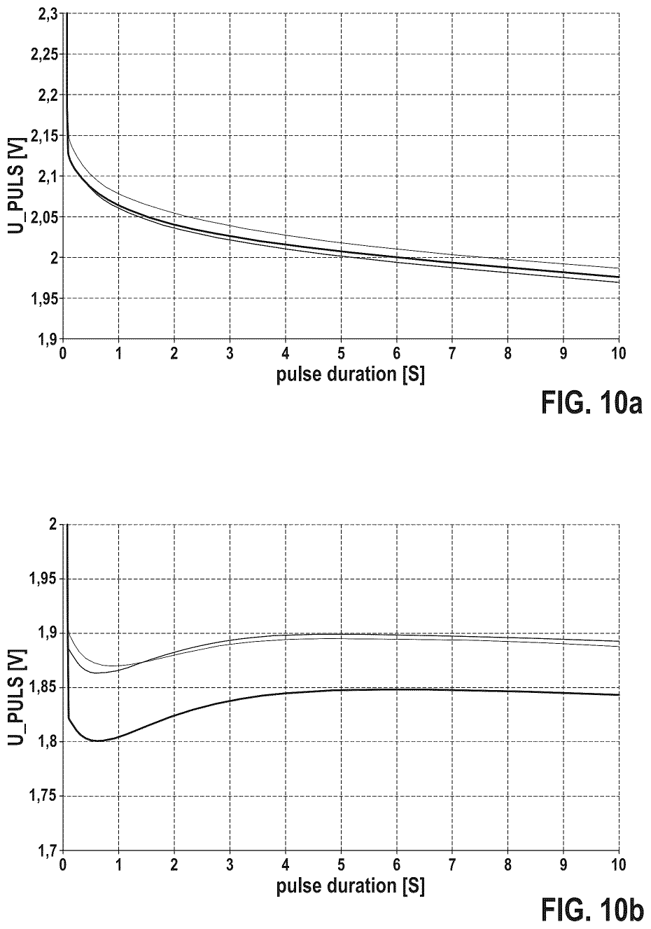

The pulse discharge curves of the 90% DOD cells according to example 1 and comparative example C1, respectively, after the 30-day recovery period are shown in FIGS. 10A and 10B.

Whereas the former exhibit the desired monotone potential decrease during the pulse duration, the latter clearly show a voltage delay, indicating the formation of a high-resistance anode surface layer. Moreover, the individual C1 cells significantly differ in their discharge behavior. In contrast, the curves of the individual example 1 cells only differ by a small margin, showing that the desired effect of geminal dinitrile additive is achieved reliably and reproducible.

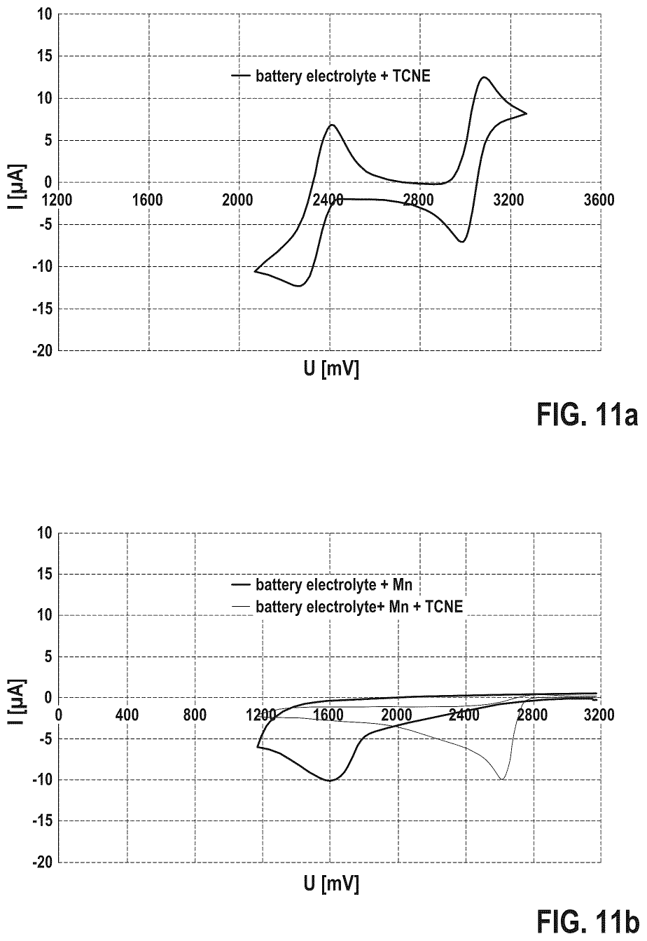

In order to gain more insight on the manganese deposition reaction, CV measurements of a) the standard electrolyte with 0.01 mol/l TNCE (see FIG. 11A), the standard electrolyte with 0.01 mol/l MnClO₄ (see FIG. 11B) and the standard electrolyte with 0.01 mol/l TCNE and 0.01 mol/l MnClO₄ (see FIG. 11B) were conducted. MnClO₄ was used to mimic the behavior of Mn^{II+} ions dissolved from the active cathode material.

Mn(II)ClO₄ has been used since during the Li/Mn(IV)O₂ cell discharge, Mn(IV) is reduced to Mn(III) and in some part of the cathode at lower voltages Mn(III) can be reduced to Mn(II) (Mn(II)₂O₃ is the soluble version of manganese dioxide).

The CV setup comprises a platinum working electrode, a platinum counter electrode and a lithium reference electrode. The scan rate was set to 50 mV/s.

The cyclic voltammogram of the standard electrolyte with TCNE as additive exhibits two reduction peaks at E_{Red1}=2.985 V and E_{Red2}=2.265 V (vs Li/Li⁺) and two corresponding oxidation peaks at E_{Ox1}=2.410 V and E_{Ox2}=3.080 V (vs Li/Li⁺). The redox behavior of TCNE is therefore reversible.

In contrast, a reversible behavior is not observed for the standard electrolyte comprising Mn^{II+} ions. The irreversible reduction peak at 1.6 V (vs Li/Li⁺) indicates the reduction and deposition of manganese on the electrode surface.

In presence of both Mn^{II} ions and a geminal dinitrile additive the redox behavior of the system is considerably altered. Whereas the absence of an oxidation peak still indicates an irreversible reaction, the reduction peak is shifted from 1.6 V to a significantly higher potential of 2.625 V (vs Li/Li⁺). This is a clear indication, that reduction reaction and the resulting reduction products have been modified. A possible explanation for this observation may be the formation of TCNE-Mn complexes in solution. Apparently, a subsequent reduction of said complexes does not lead to elemental manganese. Thus, the formation of a high-resistance anode layer is prevented.

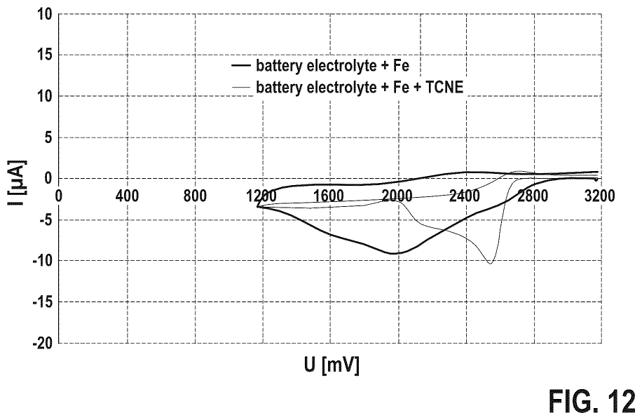

This observation is not limited to Mn^{II} ions. FIG. 12 shows a comparison of the cyclic voltammograms of standard electrolyte with and without TCNE as additive in presence of Fe^{II} ions. Fe^{II} ions were added in form of Fe(ClO₄)₂ (c=0.01 mol/l) to simulate the dissolution of Fe^{II} ions from a cathode comprising Fe^{II} as active cathode material. The CV were measured under the same conditions as outlined above.

The reduction of Fe^{II} leads to a deposition of elemental iron on the electrode surface in absence of a geminal dinitrile additive. This is indicated by an irreversible reduction peak at a potential of 1.975 V (vs. Li/Li⁺). The presence of TCNE shifts the irreversible reduction peak to a potential of 2.54 V, again indicating an alteration of reduction reaction and the resulting reduction species.

These results clearly show that geminal dinitriles as according to the present invention effectively prevent the deposition of metallic lithium on the inner surfaces as well as the formation of a high-resistance anodic layers.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

1. A primary cell comprising at least one anode, with an alkali metal as active anode material, at least one cathode with an active cathode material and an electrolyte, wherein the electrolyte comprises at least one additive, wherein the at least one additive is a nonionic or ionic compound having at least one geminal dinitrile moiety and is selected from the group consisting of aliphatic heterocycles, compounds of the formula 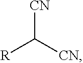
compounds of the formula 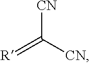
or compounds of the formula 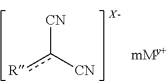
wherein M^{y+} denotes a counterion with a valence of y, and wherein R, R′ and R″ are substituents with an aliphatic or aliphatic heterocyclic backbone.

2. A primary cell according to claim 1, wherein the nonionic compounds having at least one geminal dinitrile moiety are selected from the group consisting of 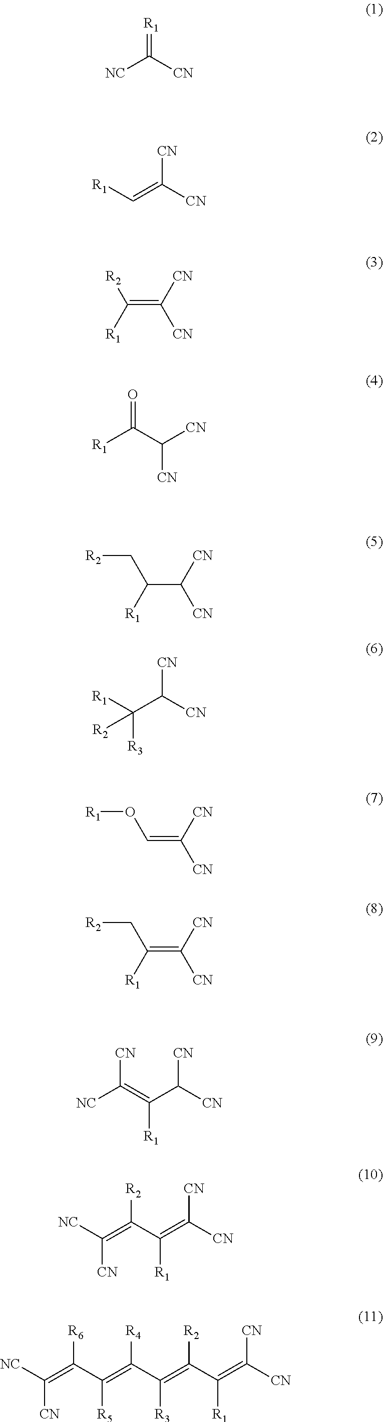 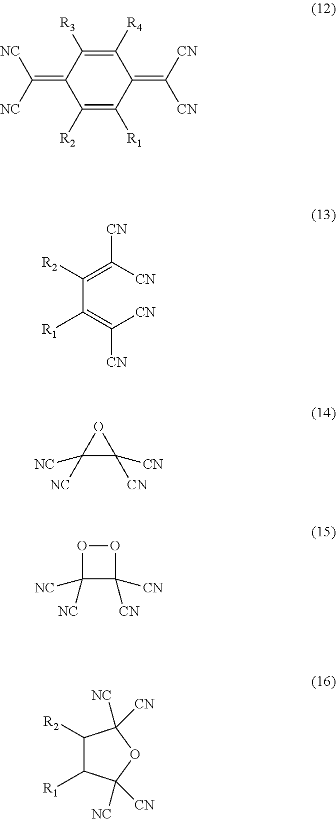
wherein R₁, R₂, R₃, R₄, R₅, and R₆, independently of one another, denote hydrogen, unsubstituted, mono- or multi-substituted alkyl, alkenyl, cycloalkyl, thioether, heterocyclic, aryl and/or heteroaryl substituents.

3. A primary cell according to claim 1, wherein the ionic compounds having at least one geminal dinitrile moiety are selected from the group consisting of 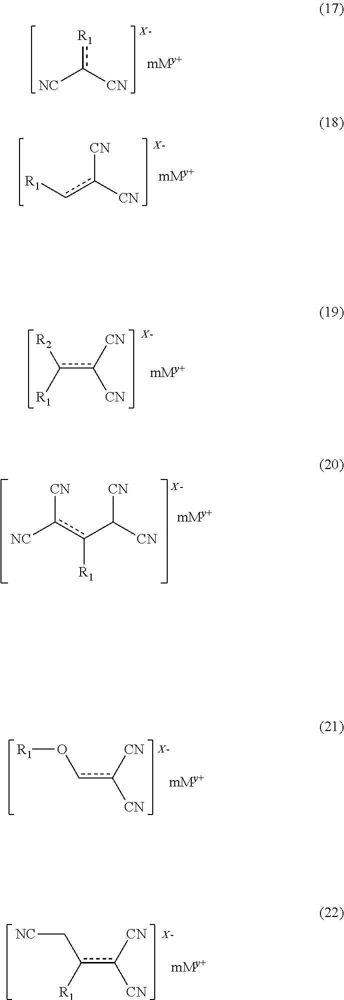 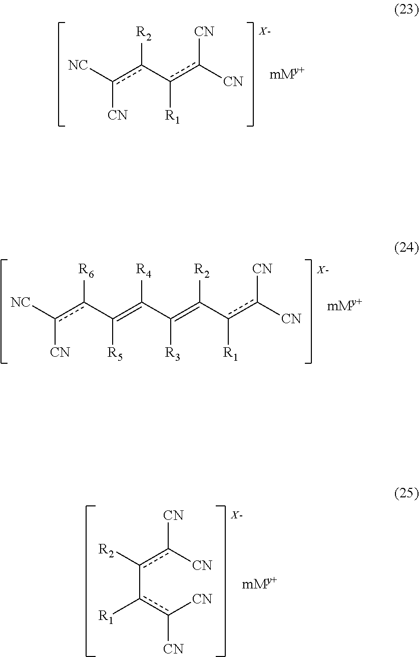
wherein R₁, R₂, R₃, R₄, R₅, and R₆, independently of one another, denote hydrogen, unsubstituted, mono- or multi-substituted alkyl, alkenyl, cycloalkyl, thioether, heterocyclic, aryl and/or heteroaryl substituents.

4. A primary cell according to claim 2, wherein the substituents of mono- or multi-substituted R₁, R₂, R₃, R₄, R₅, and R₆ moieties, independently of one another, are selected from the group comprising alkyl, fluoroalkyl, alkoxy, carbonyl, carboxyl, thiol, thioalkoxide, aryl, ether, thioether, nitro, cyano, amino, azido, amidino, hydrazino, hydrazono, carbamoyl, sulfo, sulfamoyl, sulfonylamino, alkyl-aminosulfonyl, alkylsulfonylamino moieties, and/or halogens, preferably halogens, fluoroalkyl and/or cyano moieties.

5. A primary cell according to claim 1, wherein y=1 or 2, m=1 or 2 and the counterion M^{y+} is selected from the group comprising hydroxonium, nitrosonium, ammonium, alkali metal ions, metal ions of valence y, organic ions of valence y and/or an organometallic cations of valence y for the ionic geminal dinitrile additive.

6. A primary cell according to claim 1, wherein the at least one additive has a concentration of 0.0005 mol/l to 0.5 mol/l, preferably 0.005 mol/l to 0.4 mol/l, most preferably 0.05 mol/l to 0.3 mol/l in the electrolyte.

7. A primary cell according to claim 1, wherein the alkali metal used as active anode material is metallic sodium, a sodium alloy, metallic lithium or a lithium alloy, preferably lithium or a lithium alloy.

8. A primary cell according to claim 1, wherein the active cathode material is a solid material comprising a metal, a metal oxide, a mixed metal oxide, a metal sulfide, a metal fluoride, carbonaceous compounds or mixtures thereof, preferably comprising MnO₂, silver vanadium oxide (SVO), copper silver vanadium oxide (CSVO), V₂O₂, TiS₂, CuO₂, Cu₂S, FeS, FeS₂, CFₓ, Ag₂O, Ag₂O₂, CuF, Ag₂CrO₄, CuO, copper vanadium oxide or a mixture thereof, particularly preferably comprising MnO₂.

9. A primary cell according to claim 1, wherein the primary cell is a lithium metal battery comprising at least one anode with lithium as active anode material and at least one cathode with MnO₂ as active cathode material.

10. Use of a primary cell according to claim 1 as an implantable battery or battery in a medical device, particularly an implantable medical device.

11. A medical device, particularly an implantable medical device, comprising a primary cell according to claim 1.
